(19) United States
(12) Patent Application Publication
(10) Pub. No.: US 2009/0219017 A1
(43) Pub. Date: Sep. 3, 2009

(54) Tone Wheel and Method for Manufacturing The Same

(75) Inventor: Hideo Mizuta, Okayama (JP)

Correspondence Address: BACON & THOMAS, PLLC, 625 SLATERS LANE, FOURTH FLOOR, ALEXANDRIA, VA, 22314-1176, US

(73) Assignee: Uchiyama Manufacturing Corp, Okayama (JP)

(21) Appl. No.: 12/087,678

(22) PCT Filed: Dec. 27, 2006
(86) PCT No.: PCT/JP2006/326059

§ 371 Date: Feb. 17, 2009

(30) Foreign Application Priority Data
Jan. 11, 2006 (JP) 2006-004137

(51) Int. Cl. G01B 7/30; H01F 13/00

(52) U.S. Cl. 324/207.25; 335/284

(57) ABSTRACT

A tone wheel constituting a rotation detection magnetic encoder in combination with a magnetic sensor fixed onto a stationary side member, the tone wheel comprising a metal reinforcing ring fitted in a rotary side member and a circular multipolar magnet fixed to the metal reinforcing ring. the circular multipolar magnet is made of a plastic magnet of a circular resin molded product which contains a magnetic powder therein and is magnetized with a number of S and N poles alternatively provided along its circumference. The metal reinforcing ring has a mating portion with which a part of the circular resin molded product mates. The circular resin molded product is a molded product integrally combined with the metal reinforcing ring in which a part of the circular resin molded product mates with the mating portion of the metal reinforcing ring, and is made by charging a melt resin material into a forming die in which the metal reinforcing ring is disposed and hardening the melt resin material. The metal reinforcing ring has at its edge a bent portion which is enwrapped with a part of the circular resin molded product, and the mating portion is provided at the bent portion.

### TECHNICAL FIELD

The present invention relates to a tone wheel constituting a magnetic encoder for detecting the rotation number of the wheel of automobile and more particularly relates to a tone wheel provided to detect the rotation number of the wheel to be applied to an antilock brake system or a traction control system of automobiles.

### BACKGROUND ART

The wheel of automobile is sometimes equipped with a magnetic encoder for detecting the rotation number. Such a magnetic encoder may be comprised of a tone wheel constituted with a rotating member of the wheel like a wheel bearing system together with a slinger (metal reinforcing ring) of a seal ring and a magnetic sensor which is fixed on the automobile body (stationary member side) and is provided so as to closely confront the surface of the tone wheel. On the other hand, a tone wheel may be employed such that it is fitted in and fixed to the rotary side member via a metal reinforcing ring other than the seal ring and is provided so as to confront the magnetic sensor of the automobile body. Such a tone wheel is comprised of a metal reinforcing ring which is mounted to the rotary side member to be integrally fitted and a circular multipolar magnet fixed to the metal reinforcing ring. The circular multipolar magnet may be a circular rubber magnet which is constructed such that a circular magnetic rubber sheet containing a magnetic powder is magnetized with S poles and N poles formed alternately along the circumferential direction.

The above-mentioned tone wheel with a circular rubber magnet is manufactured such that a metal reinforcing ring is placed in the cavity of a mold and an unvulcanized rubber material mixed with a magnetic powder is charged in the cavity and is bonded by vulcanization with the metal reinforcing ring to be integrally molded, and then the molded product is magnetized. In this manner, the tone wheel with the circular rubber magnet is easily manufactured in a manner that the circular rubber magnet is integrated with the metal reinforcing ring by a vulcanized adhesion at the time of molding the rubber, so that such a tone wheel is often used as a magnetic encoder for detecting the rotation.

However, when the tone wheel is used for detecting the rotation of automobile wheel, it is apt to be used in a hard circumstances where foreign materials such as water, dirt, and dust scatter, so that such foreign materials are bit between the circular multipolar magnet being a circular rubber magnet and the magnetic sensor to make the surface to be detected of the circular multipolar magnet peeled off, damaged or broken, thereby deteriorating the detection accuracy of the magnetic sensor. The flash caused at the time of molding cannot be reused because the rubber material is vulcanized, thereby increasing waste material. Under such conditions, study and developments have been proceeded for using a plastic magnet for a tone wheel. The patent documents 1-3 disclose an embodiment of a tone wheel (magnetic encoder) using a plastic magnet.

[Patent document 1] JP-2004-138597-A
[Patent document 2] JP-11-281659-A
[Patent document 3] JP-2002-340921-A

### DISCLOSURE OF INVENTION

### Problems to be Solved in the Invention

A plastic magnet is not fixed to a metal reinforcing ring when it is simultaneously and integrally molded with the metal reinforcing ring like a rubber magnet, so that the patent document 1 discloses that the plastic magnet is fixedly integrated at a predetermined portion of the metal reinforcing ring by means of adhesive after being molded in a predetermined circular shape. However, the durability of the fixed and integrated portion with adhesive is not enough under the above-mentioned hard usage environment by fixing the plastic magnet at a predetermined portion of the metal reinforcing ring only with adhesive and the plastic magnet sometimes comes off the attached portion. Further if there is any gap between the attached boundary faces, water may come into the gap and the circular multipolar magnet may be broken when the invaded water is frozen.

The patent document 2 discloses that a closed ring (metal reinforcing ring) is provided with a plurality of cutouts which are arranged at an equal space along the circumferential edge of the closed ring and are penetrated into the back face of an elastic magnet (plastic magnet) to be fixed to the closed ring. However, the cutouts are not for fixing the elastic magnet into the closed ring. Namely, the cutouts are formed only for communicating with an injection hole provided so as to inject a composite material from the back side of the elastic magnet so as to make the pulse generating face smooth and they are not provided for undertaking a role of wedging the closed ring and the elastic magnet by engaging the composite material in the cutouts nor for combining, integrally uniting and bonding them. Further, the elastic magnet is made of an elastic material such as a synthetic rubber or a synthetic resin, therefore, there remains a fear of causing peeling-off when foreign materials are bit between the magnet and the magnetic sensor.

The patent document 3 describes an elastic member freely detachable to a core member (metal reinforcing ring) in which the circumferential edge of the elastic member is provided with an engaging section and the circumferential edge of the core member is provided with a concavo-convex portion or a through hole for mating. The patent document 3 discloses a tone wheel (magnetic encoder) wherein the engaging section of the elastic member is elastically pressed and fitted in the concavo-convex portion or the through hole of the core member. However, it is supposed that the described elastic member is detachable. In case of a rubber material, it can be freely pressed and fitted in the concavo-convex portion or the through hole because of its elasticity, however, a plastic magnet has been hardly pressed and fitted therein.

Thus, a tone wheel using a plastic magnet is not suitable to be fixed and integrated with a metal reinforcing ring and has not been widely used.

The present invention is proposed in view of the above-mentioned problems and its object is to provide a credible and new tone wheel using a plastic magnet and its production method.

### Means to Solve the Problems

According to the first aspect of the present invention, the tone wheel constitutes a rotation detection magnetic encoder in combination with a magnetic sensor fixed onto a stationary side member, the tone wheel comprising a metal reinforcing ring fitted into a rotary side member and a circular multipolar magnet fixed to the metal reinforcing ring and is characterized in that the circular multipolar magnet is made of a plastic magnet of a circular resin molded product which contains a magnetic powder therein and is magnetized with a number of S and N poles alternatively provided along its circumference; that the metal reinforcing ring has an mating portion into which a part of the circular resin molded product is inserted, and that the circular resin molded product is a molded product integrally combined with the metal reinforcing ring in which a part of the circular resin molded product is inserted into the mating portion of the metal reinforcing ring, and is made by charging melt resin material into a mold in which the metal reinforcing ring is disposed and hardening the melt resin material.

The above-mentioned magnetic powder includes a ferrite powder and a rare earth powder (NdFeB, SmFeN and the like), and a resin material (binder) for a plastic magnet includes a thermoplastic resin such as nylon 6, nylon 12, nylon 66, nylon 6T, nylon 9T, polyphenylene sulfide (PPS) and the like. The magnetic powder is mixed in these resin material (additive and plasticizer are included if necessary) and molded as a resin composite product and the magnetic powder is included in the resin composite product at 70-95 weight percent. When the magnetic powder is contained less than 70 weight percent, a sufficient magnetic intensity is not obtained, but when it is contained over 95 weight percent, the binding intensity of the resin material as a binder becomes weak.

According to the present invention, as described in the second aspect, the mating portion is composed of a plurality of through holes provided on a surface of the metal reinforcing ring and that the part of the circular resin molded product is inserted into the through holes so as to pass through from its front to backward. And as mentioned in the third aspect of the invention, the mating portion is composed of a plurality of cut off parts with saw shape provided on a surface of the metal reinforcing ring and the part of the circular resin molded product is mated to the cut off parts so as to envelope the cut off parts. The plurality of through holes provided for the metal reinforcing ring may not be limited to be arranged in an equally spaced line along the circumferential direction, but may be provided in plural lines in a radial direction.

Further according to the fourth aspect of the present invention, the metal reinforcing ring has a bent portion at its edge and the circular resin molded product is integrally molded so as to cover the bent portion. According to the fifth aspect of the present invention, the bent portion can be provided with the engagement part. The bent portion can be formed at a sharp angle. Still further, as mentioned in the seventh aspect of the present invention, an edge of a combined and united portion of the circular multipolar magnet and the metal reinforcing ring is applied with an adhesive or a sealant.

The above-mentioned adhesive includes an epoxide-based adhesive and an elastomeric adhesive.

According to the eighth aspect of the present invention, the production method of a tone wheel comprising a metal reinforcing ring mounted by integrally fitting into a rotary side member and a circular multipolar magnet fixed to the metal reinforcing ring and constituting a rotation detection magnetic encoder together with a magnetic sensor fixed onto a stationary side member is characterized in that the method comprises the steps of disposing the metal reinforcing ring in a mold, the ring having an engagement part which permits engagement of a resin material; charging a resin material in the mold and integrally molding a circular resin molded product together with the metal reinforcing ring; combining and integrally uniting the circular resin molded product and the metal reinforcing ring by engaging the resin material in the engagement part and by wedging a part of the circular resin molded product in the engagement part; and forming a plastic magnet by magnetizing the circular resin molded product by providing a number of S poles and N poles alternatively in the circumferential direction.

### EFFECT OF THE INVENTION

According to the tone wheel of the first aspect of the present invention, the circular multipolar magnet is made of a plastic magnet, so that the surface to be detected is less damaged or peeled off when foreign materials are bit between the magnet and the magnetic sensor comparing with the case using a circular rubber magnet, thereby keeping measurement accuracy. Further, the circular multipolar magnet is combined and integrally united with the metal reinforcing ring by engaging the resin material into the mating portion and by wedging the hardened resin molded product with the engaged portion, so that the circular multipolar magnet does not come off when being used under a hard environment such as a detection part for the wheel rotation of automobile where foreign materials such as water, dirt and dust scatter, thereby achieving reliable rotation detection.

Further, the circular multipolar magnet is a plastic magnet made of a circular resin molded product including a magnetic powder magnetized by providing a number of S and N poles alternatively in the circumferential direction. As the result, the fluidity of the magnetic powder is high in the resin material when the magnetic powder is oriented by applying a magnetic field at the time of molding (for example, injection molding), thereby achieving a high orientation efficiency and obtaining a circular multipolar magnet with superior magnetic characteristic by being magnetized after molding. The fluidity of the magnetic powder in an unvulcanized rubber material in case of a magnetic rubber is inferior than that of the resin material, so that much magnetic powder is required or the magnetic powder is required to be oriented by applying a strong magnetic field to increase the magnetic characteristic. In addition, if the resin binder is a thermoplastic resin, the flash produced at the time of molding can be reused, thereby contributing to improve the process yield of the used material. Further, the resin material is charged in a forming die in which the metal reinforcing ring is disposed to be integrally molded, thereby reducing the manufacturing procedure and improving the production efficiency.

According to the second and the third aspects of the present invention, the resin material is mated and wedged in the mating portion, so that when the circular multipolar magnet is made of a plastic magnet, the metal reinforcing ring and the circular multipolar magnet can be firmly combined and integrally united.

According to the fourth aspect of the present invention, the metal reinforcing ring is provided with the bent portion at its edge and the circular resin molded product is integrally molded so as to cover (enwrap) the bent portion. Therefore, the coverage and integration with the bent portion and wedging of the engaged portion at the mating portion are synergized and the metal reinforcing ring and the circular multipolar magnet can be more firmly combined and integrally united.

According to the fifth aspect of the present invention, the mating portion is provided for the bent portion, so that the coverage and the integration at the bent portion are strengthen by the wedging of the engaged portion at the mating portion. Therefore, the metal reinforcing ring and the circular multipolar magnet can be more firmly combined and integrally united by a simple structure.

According to the sixth aspect of the present invention, the bent portion is sharply formed, so that the coverage and integration force is stabled and the engaging force of the circular multipolar magnet and the metal reinforcing ring is increased, thereby firmly combining and integrally uniting them.

According to the seventh aspect of the present invention, the edge of the combined and united portion of the circular multipolar magnet and the metal reinforcing ring is applied with the adhesive or the sealant, so that water is prevented from entering the combined and united portion and the magnet is prevented from being cracked when the entered water is frozen.

According to the eighth aspect of the present invention, the metal reinforcing ring having a mating portion is disposed in a mold (forming die), the resin material is charged in the mold and is integrally molded into the circular resin molded product together with the metal reinforcing ring, the resin material is mated in the mating portion at the time of molding and the mated portion being a part of the circular resin molded product is wedged, thereby combining and integrally uniting the circular resin molded product and the metal reinforcing ring. Therefore, the number of manufacturing procedure is reduced and the production efficiency is improved.

### BRIEF DESCRIPTION OF DRAWINGS

FIG. 1 is a vertical sectional view showing one embodiment of a bearing structure assembled with a tone wheel of the present invention.

FIG. 2 is an enlarged view of the area “X” in FIG. 1.

FIG. 3 is a sectional view showing one of modified examples of the tone wheel of the present invention.

FIG. 4 is a sectional view showing the other modified example of the tone wheel of the present invention.

FIG. 5 is a sectional view showing a still other modified example of the tone wheel of the present invention.

FIG. 6 is a sectional view of a tone wheel of other embodiment.

FIG. 7 is a perspective sectional view of the metal reinforcing ring in FIG. 6.

FIG. 8 is a modified example of the tone wheel of FIG. 6.

FIG. 9 is a sectional view of a tone wheel of still other embodiment.

FIG. 10 is a perspective sectional view of the metal reinforcing ring in FIG. 9.

FIG. 11 is a sectional view of a tone wheel of still other embodiment.

FIG. 12 is a perspective sectional view of the metal reinforcing ring in FIG. 11.

FIG. 13 is a modified example of the tone wheel in FIG. 11.

FIG. 14 is a sectional view of a tone wheel of still other embodiment.

FIG. 15 is a sectional view of a tone wheel of still other embodiment.

FIG. 16a-FIG. 16c show production procedures according to a production method of the present invention.

### BEST MODE FOR CARRYING OUT THE INVENTION

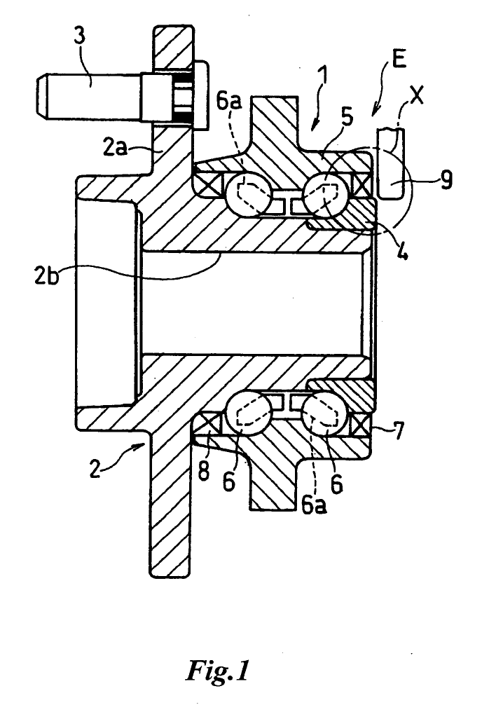

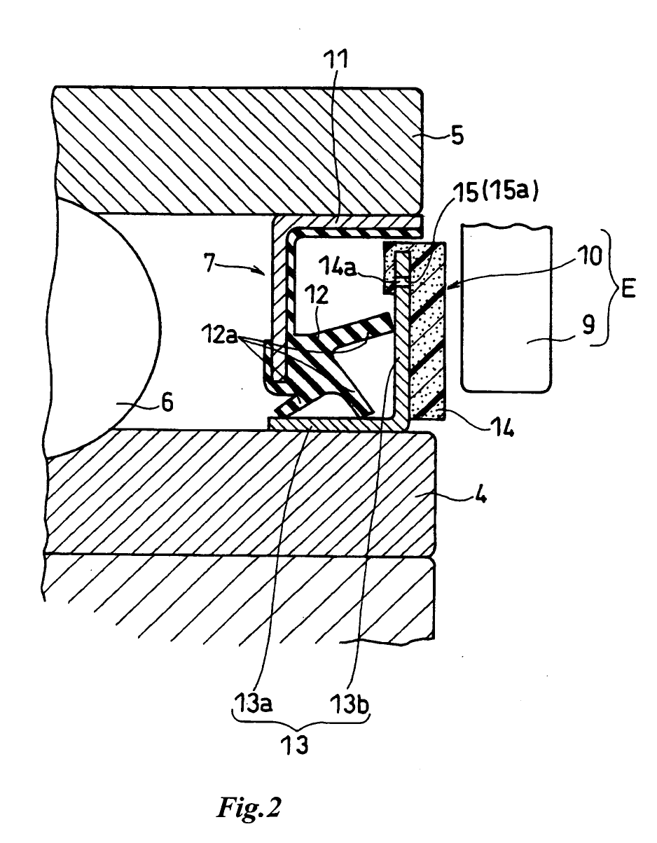

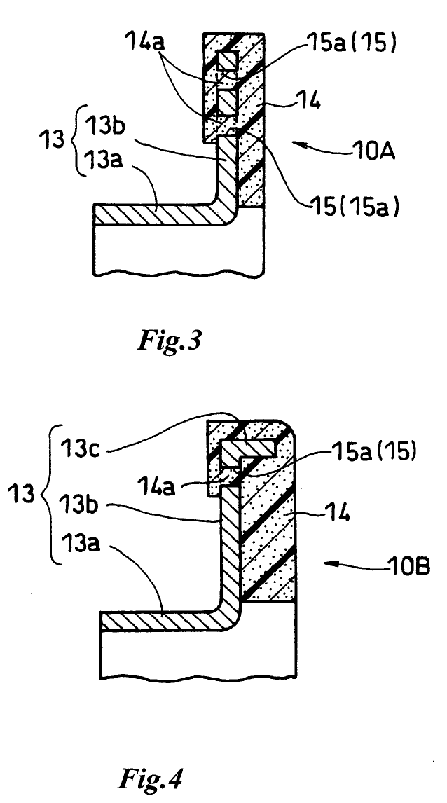

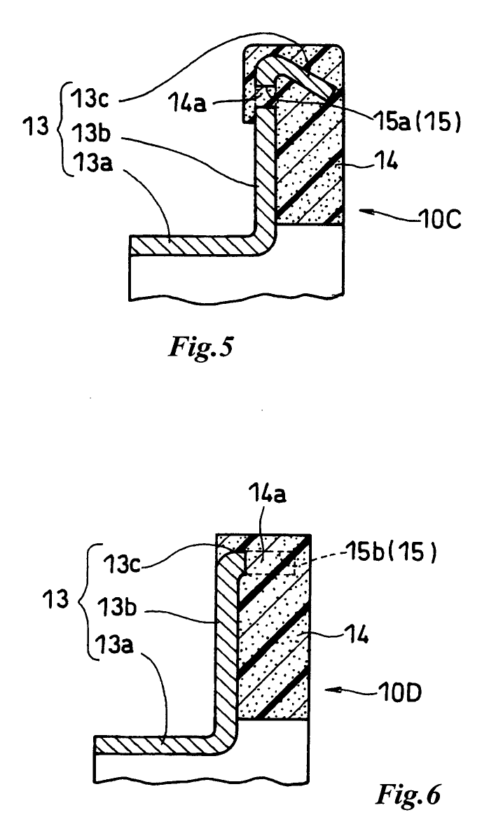

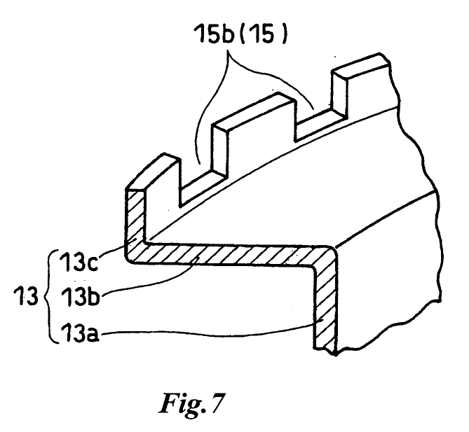

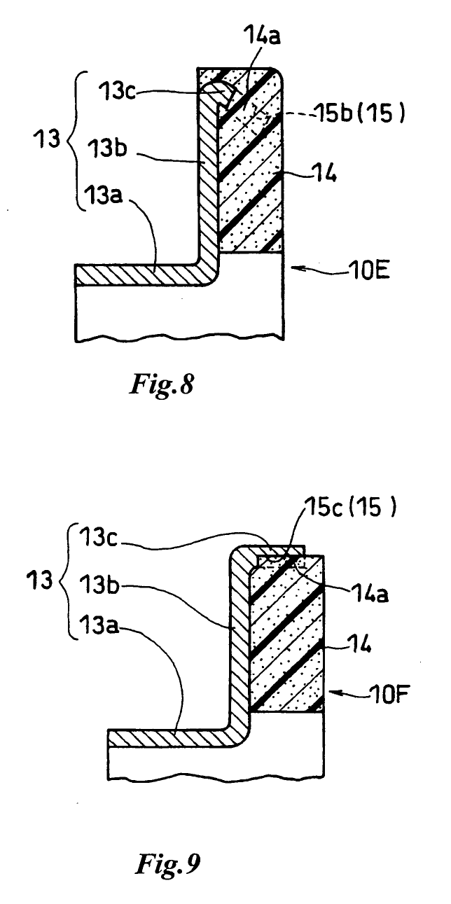

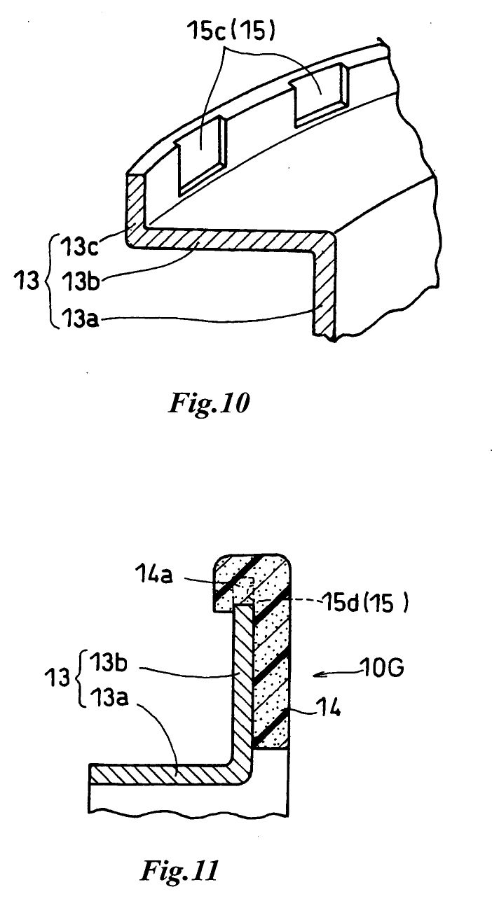

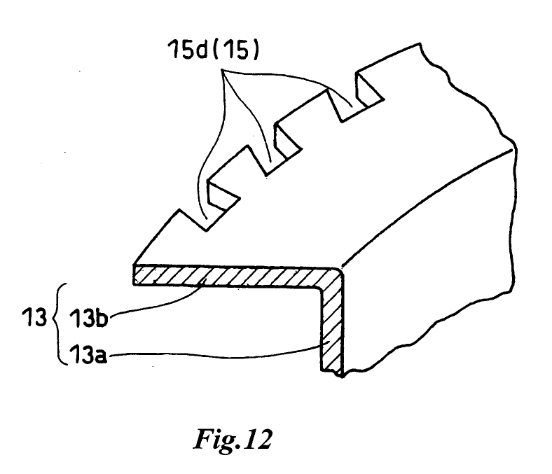

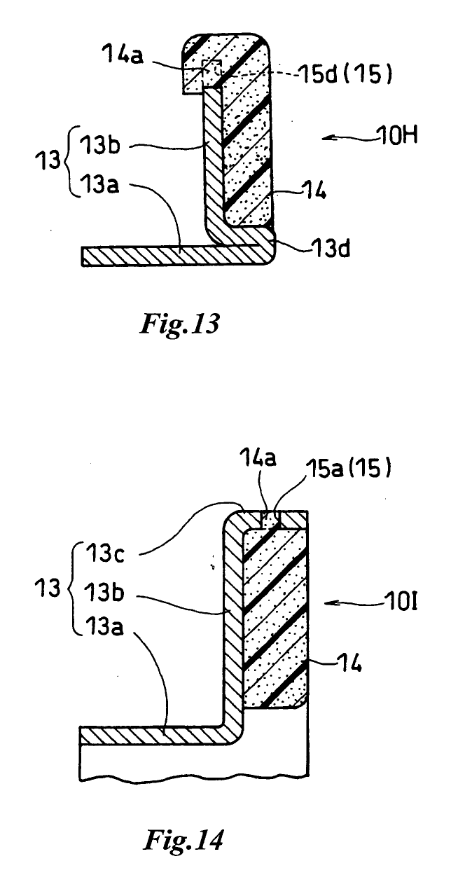

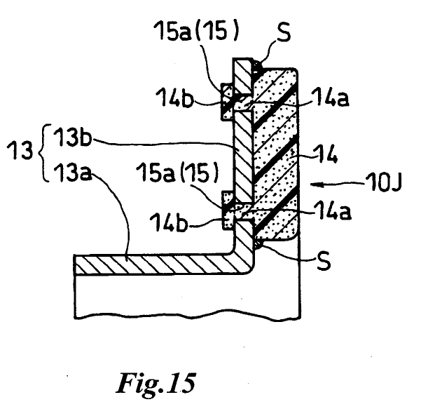

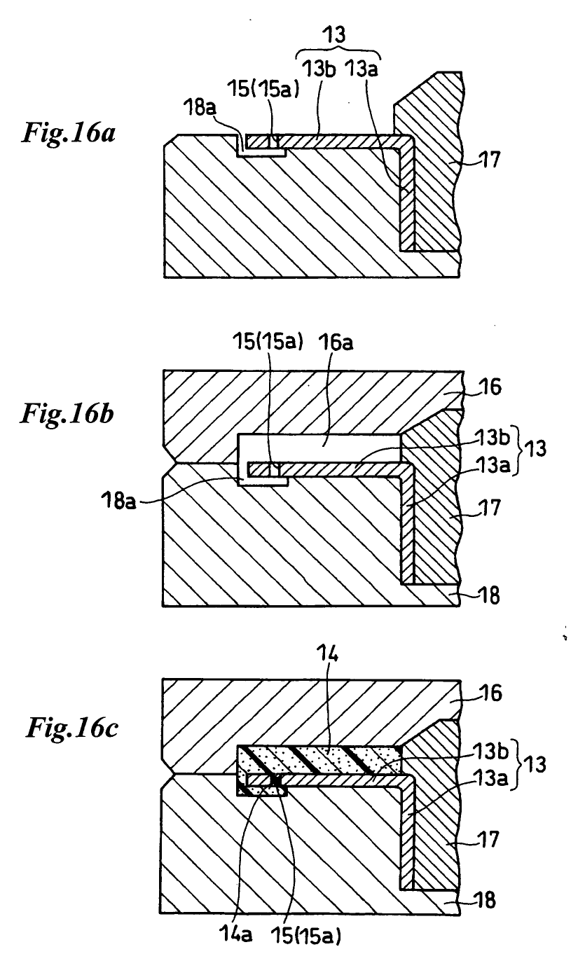

The best mode of the present invention is explained referring to the drawings. FIG. 1 is a vertical sectional view showing one embodiment of a bearing structure assembled with a tone wheel of the present invention, FIG. 2 is an enlarged view of the area “X” in FIG. 1, FIG. 3 is a sectional view showing a modified example of the tone wheel of the present invention, FIG. 4 is a sectional view showing other modified example of the tone wheel of the present invention, FIG. 5 is a sectional view showing a still other modified example of the tone wheel of the present invention, FIG. 6 is a sectional view of a tone wheel of other embodiment, FIG. 7 is a perspective sectional view of the metal reinforcing ring in FIG. 6, FIG. 8 is a modified example of the tone wheel of FIG. 6, FIG. 9 is a sectional view of a tone wheel of still other embodiment, FIG. 10 is a perspective sectional view of the metal reinforcing ring in FIG. 9, FIG. 11 is a sectional view of a tone wheel of still other embodiment, FIG. 12 is a perspective sectional view of the metal reinforcing ring in FIG. 11, FIG. 13 is a modified example of the tone wheel in FIG. 11, FIG. 14 is a sectional view of a tone wheel of still other embodiment, FIG. 15 is a sectional view of a tone wheel of still other embodiment, FIG. 16a-FIG. 16c show production procedures according to a production method of the present invention.

### Embodiment 1

FIG. 1 shows one example of a supporting structure of the vehicle wheel with a rolling bearing unit 1. A tire wheel (not shown) is fixed to a hub flange 2a of a hub 2 constituting an inner wheel (rotary side member) with a bolt 3. The drive shaft (not shown) is spline fitted in a spline shaft hole 2b formed in the hub 2 and the rotary drive force of the drive shaft is transmitted to the tire wheel. The hub 2 constitutes an inner wheel together with an inner wheel member 4. An outer wheel (fixed side member) 5 is fixed to the vehicle suspension (not shown). Two rows of rolling elements (ball) 6 . . . are interposed between the outer wheel 5 and the inner wheel (hub 2 and inner wheel member 4) while being held with a retainer 6a. Outside of the axial direction of the orbit of the two rows of rolling elements (ball) 6 . . . , seal rings 7, 8 are mounted between the outer wheel 5 and the inner wheel (hub 2 and inner wheel member 4) in order to prevent leakage of lubricant (such as grease) filled in a rolling portion of the rolling elements 6 . . . or to prevent entering of muddy water and dirt from outside. A magnetic sensor 9 is provided for the outer wheel 5 or a vehicle body (stationary side member) so as to face the outer face of the seal ring 7 at the vehicle body side and constitutes a magnetic encoder E for detecting the rotation number of the tire wheel together with a tone wheel 10 mentioned later.

FIG. 2 shows an enlarged sectional view of the mounting portion of the seal ring 7 at the vehicle body side. The seal ring 7 comprises a tone wheel 10 to be integrally fitted in the outer circumference (external peripheral face) of the inner wheel member 4, a core member 11 to be pressed and fitted into the inner circumference (inner peripheral face) of the outer wheel 5 and an elastic seal lip member 12, thereby constituting a pack seal type seal ring (referred to pack seal hereinafter). The elastic seal lip member 12 has a plurality of lips 12a . . . made of an elastic material such as rubber, of which tip ends elastically and slidably contact with the inner face (at rolling element 6 side) of the metal reinforcing ring (slinger) 13 constituting the tone wheel 10 and is fixed to the core member 11.

The tone wheel 10 is comprised of the metal reinforcing ring (slinger) 13 having a cylindrical portion 13a to be fitted and fixed in the external peripheral face of the inner wheel member 4 and an outward brim portion 13b integrally formed at an edge thereof. The tone wheel 10 is also comprised of a circular plastic magnet (circular multipolar magnet) 14 which is combined and integrally united to the outer face (at vehicle body side) of the outward brim portion 13b. The plastic magnet 14 is formed such that the above-mentioned binder resin including the aforesaid magnetic powder is molded in a circular shape and is magnetized by providing a plurality of N poles and S poles alternately along the circumferential direction. Therefore, the magnetic change of the magnetized portion by rotation of the tone wheel 10 accompanied with rotation of the hub 2 and the inner wheel member 4 is detected by the magnetic sensor 9 and the rotation (rotation speed and its direction) of the wheel is detected.

The metal reinforcing ring 13 has a mating portion 15 for allowing a part of the resin molded body to be mated, a resin material is charged in a mold in which the metal reinforcing ring 13 is placed to be molded together. Accordingly, a part of resin material is inserted in the mating portion 15 and the cured circular resin molded product is combined and integrally united into the metal reinforcing ring 13 by wedging with an engaged portion 14a. If the mating portion 15 is designed to be a plurality of through holes 15a provided through the front face to the back face of the metal reinforcing ring 13 as shown in FIG. 2, the wedging of the engaged portion 14a of the resin material at the through holes 15a is achieved by communicating from the outside (vehicle body side) into the inside (rolling element 6 side) of the outward brim portion 13b of the metal reinforcing ring 13 as if they are tacked. If these through holes 15a are provided with an equal space through the front to back faces of the metal reinforcing ring 13 and the space is set small, the metal reinforcing ring 13 can be firmly wedged in a balanced manner, however, the present invention is not limited to it.

Therefore, in case of detecting rotation at a rotating part at high speed like wheels of a vehicle, the fixed strength of the metal reinforcing ring 13 and the plastic magnet 14 is not enough if the through holes 15a of the present invention are not provided. However, a part of resin material is mated in the through holes 15a if the through holes 15a are provided like the present invention, and the metal reinforcing ring 13 and the plastic magnet 14 are combined and integrally united by the wedging function of the engaged portion 14a, thereby increasing the united strength and preventing the plastic magnet from coming off (drop-out into the axial direction, going-around in circles, or displacement of the outward brim portion 13b into the surface area by the centrifugal force). Specifically according to the present invention, a hard plastic magnet having inferior elasticity comparing with the prior rubber magnet can be combined and integrally united with the metal reinforcing ring 13, thereby being effective.

When an adhesive is applied on the faces to be fixed of the metal reinforcing ring 13 and the plastic magnet 14 at the time of molding, the adhesion force of the adhesive, the wedging force of the through holes 15a and the engaged portion 14a are synergized to achieve more firm combination and integral unification. As the result, the characteristic of the plastic magnet 14 is utilized and the adequacy of rotation detection for vehicle motors is increased. Adhesive is preferably an epoxide-based adhesive having strong adhesion force, however, an elastic adhesive such as a sealant and an elastomeric adhesive may be used. Specifically, the coefficient difference of thermal expansion is large between the metal reinforcing ring and the plastic magnet, so that there causes the thermal expansion difference between them under the environment where the temperature is significantly changed. If an elastic adhesive is used, the elasticity of the elastic adhesive layer may absorb the thermal expansion difference, thereby preventing peeling and breaking of the plastic magnet in advance.

When the adhesive and a sealant S mentioned later are applied on the edge of the combined and united portion of the plastic magnet 14 and the metal reinforcing ring 13 (not shown in FIG. 2), water does not enter into the combined and united portion, thereby effectively preventing breakage of the plastic magnet 14 when the entered water gets frozen and therefore increasing its durability.

Further, the fixing faces of the plastic magnet 14 and the metal reinforcing ring 13 are set to have a surface roughness greater than or equal to Ra0.8. The slip resistance of the fixing face is increased by such a surface roughness, so that it supplementarily prevents displacement of the plastic magnet 14 to more firmly combine and integrally unite the plastic magnet 14 and the metal reinforcing ring 13.

Although the tone wheel 10 is designed to be one constituting member of the pack seal 7 in this embodiment, the magnetic encoder E may be constructed such that the tone wheel 10 is fitted in the rotary side member as a single member and the magnetic sensor 9 is arranged to confront the tone wheel 10. FIG. 1 and FIG. 2 show an example of a bearing unit 1 of the driving wheel in which the inner wheel is rotated. However, it goes without saying that the present invention can be applied to the bearing unit of a driven wheel when the outer wheel is rotated. In this case, the tone wheel 10 is fitted and fixed in the outer wheel being a rotary side member.

The tone wheel 10A-10C in FIG. 3-FIG. 5 respectively shows a modified example of the above-mentioned embodiment wherein the configuration of the metal reinforcing ring 13 is different. The tone wheel 10A in FIG. 3 is the same as the above embodiment in that a plurality of through holes 15a are provided for the metal reinforcing ring 13, however they are different in that this example is provided with two rows of through holes 15a equally spaced along the circumferential direction. According to this configuration, the metal reinforcing ring 13 and the plastic magnet 14 are more firmly combined and integrally united by the wedging of the engaged portion 14a.

According to the tone wheel 10B in FIG. 4, the metal reinforcing ring 13 comprises the cylindrical portion 13a, the outward brim portion 13b and a large caliber cylindrical portion 13c (bent portion) concentrically extending in direction opposite to the cylindrical portion 13a at the outer circumferential end of the outward brim portion 13b. The circular resin molded product is integrally molded so as to cover the large caliber cylindrical portion 13c. Therefore, the wedging of the engaged portion 14a and the coverage of the large caliber cylindrical portion 13c are synergized so that the metal reinforcing ring 13 and the plastic magnet 14 are more firmly combined and integrally united.

Further according to the tone wheel 10C in FIG. 5, the large caliber cylindrical portion 13c is bent at an acute angle. The circular resin molded product is integrally molded so as to cover the large caliber cylindrical portion 13c like the embodiment in FIG. 4. When the large caliber cylindrical portion 13c of the metal reinforcing ring 13 is formed by bending at sharp angle (acute angle), the uniting strength at the axial direction is more increased by the coverage of the sharply bent portion, so that the metal reinforcing ring 13 and the plastic magnet 14 are more firmly combined and integrally united.

The other constructions of FIG. 3-FIG. 5 are the same as those of FIG. 1 and FIG. 2, the common members are allotted with the same reference numerals and their explanations are omitted here. The tone wheels 10A-10C may be a constitution member of the pack seal 7 as shown in FIG. 1 and FIG. 2, and otherwise they may be fitted in the rotary side member as a single member, or may be used for detecting the rotation of a driven wheel when the outer wheel is rotated, as mentioned above.

### Embodiment 2

FIG. 6 shows a tone wheel of other embodiment. According to the tone wheel 10D of this embodiment, the mating portion 15 formed from the front to back faces of the metal reinforcing ring 13 comprises a plurality of cutouts like teeth 15b (cut-off parts with saw shape) formed along the circumferential direction of the large caliber cylindrical portion 13c of the embodiment of FIG. 4 and this embodiment is different from the above-mentioned embodiment in that the wedging of the engaged portion 14a of the resin material is executed by engaging in a manner of biting with the cutouts 15b. FIG. 7 shows a perspective sectional view of the metal reinforcing ring 13 used in this embodiment. The cutouts 15b like teeth are formed at the large caliber cylindrical portion 13c by cutting out in a rectangular shape, however, it is not limited to such form. If it is in a shape of trapezium (tapered shape), it can provide such structure that the plastic magnet 14 hardly comes off.

The figure shows the circular resin molded product is integrally molded so as not to cover the inner face (rolling element 6 side) of the outward brim portion 13b. According to this figure, in case of a pack seal type shown in FIG. 2, the sliding contact face of the lip 12a is obtained widely, so that the sealing design is facilitated and a high sealing ability can be achieved. The structure of the circular resin molded product is not limited to this, and if it is designed to reach the inner face as shown in FIG. 4 and FIG. 5, the coverage and holding force is increased and the metal reinforcing ring 13 and the plastic magnet 14 are more firmly combined and integrally united. The cutouts 15b like teeth in the figure are formed at equal space around the circumferential direction of the large caliber cylindrical portion 13c, however, it is not limited to the embodiment in the figure.

FIG. 8 shows a modified example of the above-mentioned embodiment in which the large caliber cylindrical portion 13c is bent at an acute angle. When the large caliber cylindrical portion 13c of the metal reinforcing ring 13 is sharply bent, the uniting strength at the axial direction is more increased by the coverage of the sharply bent portion, so that the metal reinforcing ring 13 and the plastic magnet 14 are more firmly combined and integrally united.

The figure shows the circular resin molded product is integrally molded so as not to cover the inner face (rolling element 6 side) of the outward brim portion 13b. According to this figure, in case of a pack seal type shown in FIG. 2, the sliding contact face of the lip 12a is obtained widely, so that the sealing design is facilitated and a high sealing ability can be achieved. The structure of the circular resin molded product is not limited to this, and if it is designed to reach the inner face as shown in FIG. 4 and FIG. 5, the coverage and holding force of the sharply bent portion, the biting force of the cutouts 15b and the coverage into the inner face are synergized, so that the metal reinforcing ring 13 and the plastic magnet 14 are more firmly combined and integrally united.

The other constructions of FIG. 6 and FIG. 8 are the same as those of FIG. 1 and FIG. 2, the common members are allotted with the same reference numerals and their explanations are omitted here. The tone wheels 10D and 10E may be a constitution member of the pack seal 7 as shown in FIG. 1 and FIG. 2, and otherwise they may be fitted in the rotary side member as a single member, or may be used for detecting the rotation of a driven wheel when the outer wheel is rotated, as mentioned above.

### Embodiment 3

FIG. 9 shows a tone wheel of other embodiment. According to the tone wheel 10F of this embodiment, the mating portion 15 of the metal reinforcing ring 13 comprises a plurality of cutouts 15c like teeth (cut-off parts with saw shape). This embodiment is different from the above-mentioned embodiment in that the cutout 15c is not formed from the front face to the back face of the metal reinforcing ring 13. Namely, the cutout 15c formed for the tone wheel 10F of this embodiment is formed like a groove in which a half of the inner circumference of the large caliber cylindrical portion 13c of the metal reinforcing ring 13 is scraped as shown in FIG. 10. FIG. 10 shows a perspective sectional view of the metal reinforcing ring 13 used in this embodiment. The cutouts 15b like teeth are formed in a rectangular shape in the figure, however, it is not limited to such form. It may be in a form of a trapezium (dovetail) like the embodiment 2. If it is in a trapezium, it can provide such a structure that the plastic magnet 14 hardly comes off. The figure shows the circular resin molded product is integrally molded so as not to cover the inner face (rolling element 6 side) of the outward brim portion 13b. According to this figure, in case of a pack seal type shown in FIG. 2, the sliding contact face of the lip 12a is obtained widely, so that the sealing design is facilitated and a high sealing ability can be achieved. The structure of the circular resin molded product is not limited to this, and if it is designed to reach the inner face as shown in FIG. 4 and FIG. 5, the coverage and holding force is increased and the metal reinforcing ring 13 and the plastic magnet 14 are more firmly combined and integrally united.

The other constructions of FIG. 9 are the same as those of FIG. 1 and FIG. 2, the common members are allotted with the same reference numerals and their explanations are omitted here. The tone wheel 10F may be a constitution member of the pack seal 7 as shown in FIG. 1 and FIG. 2, and otherwise they may be fitted in the rotary side member as a single member, or may be used for detecting the rotation of a driven wheel when the outer wheel is rotated, as mentioned above.

### Embodiment 4

FIG. 11 shows a tone wheel of other embodiment. According to the tone wheel 10G of this embodiment, this embodiment is the same as the embodiment 2 in that the mating portion 15 formed from the front face to the back face of the metal reinforcing ring 13 comprises a plurality of cutouts like teeth 15b and the wedging of the engaged portion 14a of the resin material is executed by biting with the cutout 15b, however, the configuration of the metal reinforcing ring 13 is different. The metal reinforcing ring 13 comprises the cylindrical portion 13a to be fitted and fixed into the external peripheral face of the inner wheel member 4 and the outward brim portion 13b integrally connected at the edge like the embodiment 2 and the cutout 15b like teeth is formed at the outward brim portion 13b. FIG. 12 shows a perspective sectional view of the metal reinforcing ring 13 used in this embodiment. If the cutout 15d is formed in a shape of trapezium (dovetail) in which the opening is narrowly shaped, it can provide such a structure that the plastic magnet 14 hardly comes off. However, this embodiment is not limited to this shape and it may be cutout in a rectangular shape.

FIG. 13 shows a modified example of the above-mentioned embodiment. According to this tone wheel 10H, the outward brim portion 13b of the metal reinforcing ring 13 is extended from the end of the cylindrical portion 13a via a folded portion 13d and such a tone wheel is used in this embodiment. By such a configuration of the metal reinforcing ring 13, the fit-in portion by the bent portion 13d and the wedging function of the engaged portion 14a are synergized and the metal reinforcing ring 13 and the plastic magnet 14 are more firmly combined and integrally united.

The other constructions of FIG. 11 and FIG. 13 are the same as those of FIG. 1 and FIG. 2, the common members are allotted with the same reference numerals and their explanations are omitted here. The tone wheels 10G and 10H may be a constitution member of the pack seal 7 as shown in FIG. 1 and FIG. 2, and otherwise they may be fitted in the rotary side member as a single member, or may be used for detecting the rotation of a driven wheel when the outer wheel is rotated, as mentioned above.

### Embodiment 5

FIG. 14 shows a tone wheel of other embodiment. The tone wheel 10I of this embodiment is different from the above embodiment in that a through hole 15a is provided for the bent portion of the metal reinforcing ring 13, namely the large caliber cylindrical portion 13c. A plurality of through holes 15a are provided from the front face to the back face of the large caliber cylindrical portion 13c and the wedging of the engaged portion 14a of the resin material is done by the through holes 15a like the embodiment 1. Accordingly, the metal reinforcing ring 13 and the plastic magnet 14 can be firmly combined and integrally united by the wedging of the resin material inserted in the through holes 15a by a simple structure. Further, an integral molding is possible without complicating the structure of molds because of the simple structure of the combination. In case of a pack seal type shown in FIG. 2, the sliding contact face of the lip 12a is obtained widely, so that the sealing design is facilitated and a high sealing ability can be achieved.

The other constructions of FIG. 14 are the same as those of FIG. 1 and FIG. 2, the common members are allotted with the same reference numerals and their explanations are omitted here. The tone wheel 10I may be a constitution member of the pack seal 7 as shown in FIG. 1 and FIG. 2, and otherwise they may be fitted in the rotary side member as a single member, or may be used for detecting the rotation of a driven wheel when the outer wheel is rotated, as mentioned above.

### Embodiment 6

FIG. 15 shows a tone wheel of other embodiment. The tone wheel 10J of this embodiment is the same as the above-mentioned embodiment 1 in that a plurality of through holes 15a are provided from the front face to the back face of the metal reinforcing ring 13 and the wedging of the engaged portion of the resin material is done by communicating through the front and back faces of the metal reinforcing ring 13 via the through holes 15a so as to be tacked. However, they are different in that an engaging section 14b is formed with the resin material communicated in the through holes 15a. The sealant S is shown in FIG. 15. The sealant S is applied on the edge of the combined and united portion of the metal reinforcing ring 13 and the plastic magnet 14, thereby preventing invasion of water and improving the durability of the tone wheel 10J. As shown in FIG. 15, when the plastic magnet 14 is fixed so as to be projected out of the metal reinforcing ring 13 and to face the magnetic sensor 9, it is more effective to apply the sealant S because the plastic magnet 14 is apt to be attacked by water and so on. In this embodiment, the sealant S is applied on the edge of the combined and united portion of the metal reinforcing ring 13 and the plastic magnet 14, however, the present invention is not limited to this embodiment and an epoxide-based adhesive and an elastomeric adhesive may be applied.

The other constructions of FIG. 15 are the same as those of FIG. 1 and FIG. 2, the common members are allotted with the same reference numerals and their explanations are omitted here. The tone wheel 10J may be a constitution member of the pack seal 7 as shown in FIG. 1 and FIG. 2, and otherwise they may be fitted in the rotary side member as a single member, or may be used for detecting the rotation of a driven wheel when the outer wheel is rotated, as mentioned above.

Next, the production method according to the present invention is explained.

FIG. 16a-FIG. 16c show production procedures according to the production method of the present invention. FIG. 16a is a vertical sectional view in which the metal reinforcing ring 13 with the mating portion 15 (through hole 15a) is placed in a lower mold 18 and a core 17 is assembled, FIG. 16b is a vertical sectional view in which an upper mold 16 is set, and FIG. 16c is a vertical sectional view in which a resin material is charged in the mold from a charge port (not shown) and cured.

At first, the metal reinforcing ring 13 is disposed on the lower mold 18, then the lower mold 18 and the core 17 are assembled. The lower mold 18 has a cavity 18a formed in a desirable shape in such a manner that the metal reinforcing ring 13 is disposed thereon and the resin material inserted from the mating portion 15 provided at the edge of the metal reinforcing ring 13 can cover the metal reinforcing ring 13 to go therearound.

Next, the upper mold 16 is set (see FIG. 16b), and the resin material is charged from the charge port into the mold to integrally mold the circular resin molded product with the metal reinforcing ring 13 (see FIG. 16c). The upper mold 16 has a cavity 16a formed in accordance with the main shape of the circular resin molded product.

In case of charging and molding, the resin material is mated in the above-mentioned mating portion 15 and the circular resin molded product and the metal reinforcing ring 13 are combined and integrally united by the wedging of the engaged portion 14a which is a part of the circular resin molded product. After the circular resin molded product is cured, it is magnetized by providing a plurality of S poles and N poles alternately along its circumferential direction, thus forming the plastic magnet 14 and obtaining the integrally molded tone wheel. It goes without saying that the fixing face of the metal reinforcing ring 13 and the circular resin molded product is applied with adhesive at the time of molding. The upper mold 16 and the core 17 may be an integrated mold.

The configuration of the mating portion 15 is not limited to the one in the figures and the application examples of the tone wheel of the present invention are not limited in the above-mentioned embodiments. As far as the tone wheel is attached to the rotary side member and constitutes the magnetic encoder together with the magnetic sensor provided for the stationary side member, it goes without saying that the tone wheel can be applied to the rotary side member such as the bearing, the bearing unit or the rotary shaft (driving shaft) at the rotating part which requires to detect the rotation. The tone wheels 10, 10A-10J in the above-mentioned embodiments constitute an axial encoder, however, it goes without saying that the present invention is applicable to constitute a radial encoder. Further, the metal reinforcing ring 13 in the figure is constructed such that the cylindrical portion 13a is fitted and fixed in the external peripheral face of the inner wheel member 4 (rotary side member) and the outward brim portion 13b is formed at its edge. However, the present invention is not limited to such a structure and it goes without saying that the present invention can be applied for an embodiment in which a brim portion (not shown) is formed at the edge of the cylindrical portion 13a inwardly relative to the axial direction.

1. A tone wheel constituting a rotation detection magnetic encoder in combination with a magnetic sensor fixed onto a stationary side member, said tone wheel comprising a metal reinforcing ring fitted in a rotary side member and a circular multipolar magnet fixed to said metal reinforcing ring, wherein:
said circular multipolar magnet is made of a plastic magnet of a circular resin molded product which contains a magnetic powder therein and is magnetized with a number of S and N poles alternatively provided along its circumference; wherein
said metal reinforcing ring has a mating portion with which a part of said circular resin molded product mates, (and) wherein
said circular resin molded product is a molded product integrally combined with said metal reinforcing ring in which a part of said circular resin molded product mates with said mating portion of said metal reinforcing ring, and is made by charging a melt resin material into a forming die in which said metal reinforcing ring is disposed and hardening said melt resin material, wherein
said metal reinforcing ring has at its edge a bent portion which is enwrapped with a part of said circular resin molded product, and wherein
said mating portion is provided at said bent portion.

2. The tone wheel as set forth in claim 1, wherein said mating portion is composed of a plurality of through holes provided on a surface of said metal reinforcing ring and wherein said part of said circular resin molded product is inserted into said through holes so as to pass through from its front to backward.

3. The tone wheel as set forth in claim 1, wherein said mating portion is composed of a plurality of cut off parts with saw shape provided on a surface of said metal reinforcing ring and wherein said part of said circular resin molded product is mated to said cut off parts so as to envelope said cut off parts.

4. (canceled)

5. (canceled)

6. The tone wheel as set forth in claim 1, wherein said bent portion has an acute angle.

7. The tone wheel as set forth in claim 1, wherein an adhesive or a sealant is further applied to a circumferential gap between said circular multipolar magnet and said metal reinforcing ring.

8. A production method of a tone wheel constituting a rotation detection magnetic encoder in combination with a magnetic sensor fixed onto a stationary side member, said tone wheel comprising a metal reinforcing ring fitted in a rotary side member and a circular multipolar magnet fixed to said metal reinforcing ring, said method comprising the steps of:
placing in a forming die said metal reinforcing ring having at its edge a bent portion and having a mating portion with which a part of said resin material mates;
charging a melt resin material into said forming die to produce the circular resin molded product integrally combined with said metal reinforcing ring in which a part of said circular resin molded product mates with said mating portion of said metal reinforcing ring; and
producing a plastic magnet by magnetizing said circular resin molded product by providing a number of S and N poles alternatively along its circumference.

9. The tone wheel as set forth in claim 2, wherein an adhesive or a sealant is further applied to a circumferential gap between said circular multipolar magnet and said metal reinforcing ring.

10. The tone wheel as set forth in claim 3, wherein an adhesive or a sealant is further applied to a circumferential gap between said circular multipolar magnet and said metal reinforcing ring.

11. The tone wheel as set forth in claim 6, wherein an adhesive or a sealant is further applied to a circumferential gap between said circular multipolar magnet and said metal reinforcing ring.
